(19) United States
(12) Patent Application Publication
(10) Pub. No.: US 2019/0266927 A1
(43) Pub. Date: Aug. 29, 2019

(54) COMPOSITE STRUCTURE USEFUL AS, OR AS A PART OF, A BILLBOARD SYSTEM

(71) Applicant: METROMEDIA COMPANY, New York, NY (US)

(72) Inventor: William ISHIDA, Chagrin Falls, OH (US)

(21) Appl. No.: 16/266,652

(22) Filed: Feb. 4, 2019

Related U.S. Application Data
(60) Provisional application No. 62/634,453, filed on Feb. 23, 2018.

(51) Int. Cl. G09F 9/30; G09F 9/302

(52) U.S. Cl. CPC G09F 9/301; G09F 9/33; G09F 9/3026

(57) ABSTRACT

The invention involves a composite lighting structure, such as a billboard. It utilizes non-electroluminescent carpets for lighting. A framing element surrounds a support structure, and a graphic wrap covers it. Batten means separate the graphic wrap from the light carpet.

### RELATED APPLICATION

This application claims priority from Provisional Application No. 62/634,453 filed Feb. 23, 2018, incorporated by reference in its entirety.

### FIELD OF THE INVENTION

The present invention is directed to composite structure lighting systems. The invention employs light emitting diode (LED)-illuminated carpets in a mounting system. The system can be adapted for use on conventional, pre-existing structures, as well as and also as billboards per se.

### BACKGROUND OF THE INVENTION

Billboards are structures typically used to display graphics, menus, or other information in outdoor locations. These billboards may be free-standing (e.g., along highways, roads, etc.) or installed on other structures (e.g., on the side of a building, on top of a stadium, on the side of a truck, etc.). During daylight hours, the sign can be visible without any additional lighting structures.

Traditional billboards usually measure 14 feet by 48 feet and contain lighting structures installed on the front of the billboard structure that are directed toward the sign in order to light the sign and improve its visibility, for example, during nighttime hours or bad weather conditions.

With new technology, lighting systems, such as the LED, have been introduced.

Various types of composite lighting systems and billboards are known from the prior art. See, e.g., U.S. Pat. No. 10,121,396, incorporated by reference in its entirety. Also see U.S. Pat. No. 9,767,719, also incorporated by reference in its entirety. Further exemplars can be found in U.S. Pat. Nos. 8,844,179; 7,063,449; 4,943,689; and 3,680,238, as well as published U.S. Patent Applications 2014/0192530; 2012/0266507; 2012./0120080; 2012/0013806; 2011/00839824; 2011/0057215; 2011/0056102; 2011/0051409; 2011/0019348; 2009/0289160; 2005/0178034; 2004/0163291; and 2002/0163791. The field exhibits a need for further developments, such as the invention described herein.

### BRIEF DESCRIPTION OF THE INVENTION

Disclosed in various embodiments are composite structure, LED lighting systems, which can be used as, or as part of, billboard systems. Although the lighting system described herein is particularly directed to LED lighting system, it will be appreciated that other types of lighting systems can be used (e.g., plasma lighting systems, incandescent lighting systems, halogen lighting systems, florescent lighting systems, etc.).

In another non-limiting embodiment of the present invention, there is provided an assembled LED panel unit which, when on billboard structures or on other structures, serves to illuminate the billboard graphic from behind.

In yet another non-limiting embodiment of the present invention, there is provided a novel lighting system for illumination of billboard graphics as needed or required, such as, but not limited to low visibility conditions (e.g., dusk, dawn, nighttime hours, mist conditions, rain conditions, snow conditions, etc.).

In still yet another non-limiting embodiment of the present invention there is provided one or more assembled LED panel units which can easily and conveniently be attached to pre-existing billboard structures.

These and other objects, features, and advantages of the present invention will become apparent from the subsequent description taken in conjunction with the accompanying drawings.

### DETAILED DESCRIPTION OF PREFERRED EMBODIMENTS

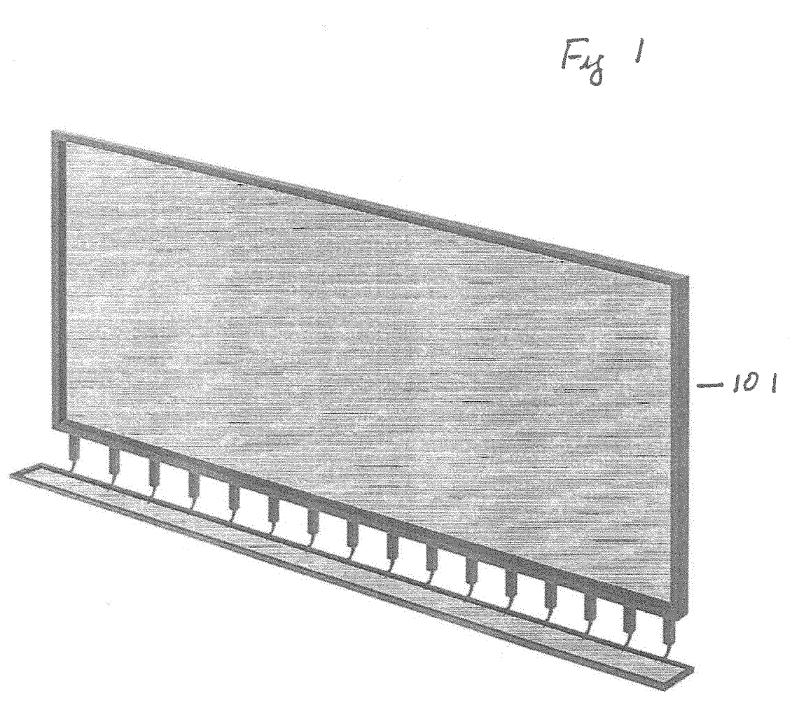

Referring to the figures, FIG. 1 shows a support structure including a display board “101.” The structure of FIG. 1 is the “template” for the invention which follows.

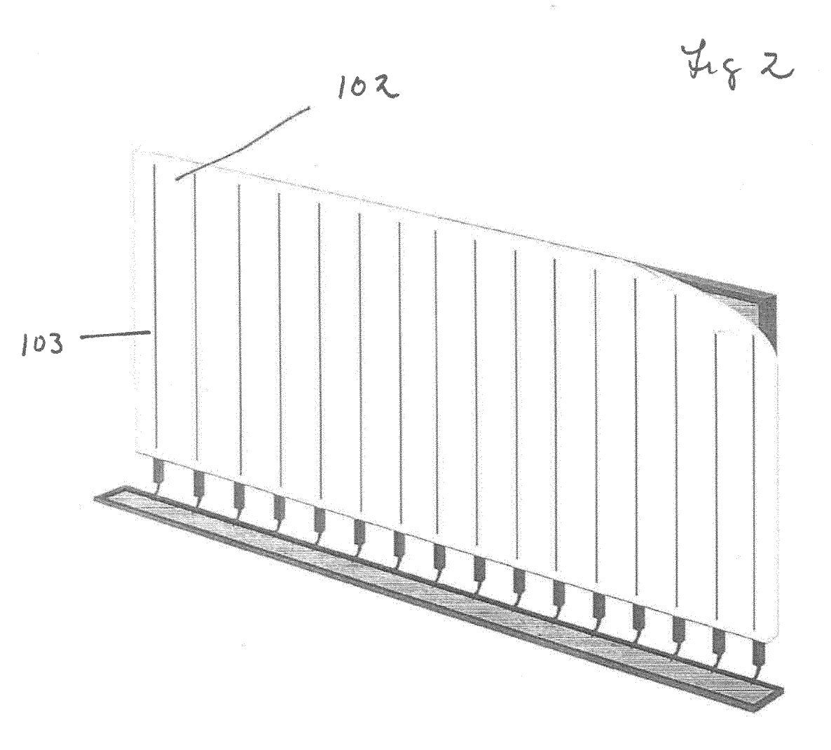

In FIG. 2, an opaque backing “102,” which may be, for example, a flexible sheet. This flexible sheet means is attached to support structure 101 via any non-invasive attachment means known to the art.

It is critical that flexible sheet means “102” be opaque, and in some embodiments one side, which is the side which faces the display board 101, is black. Preferably, the material used is vinyl, but other weather resistant materials such as plastics, rubber, and other synthetic materials can be used.

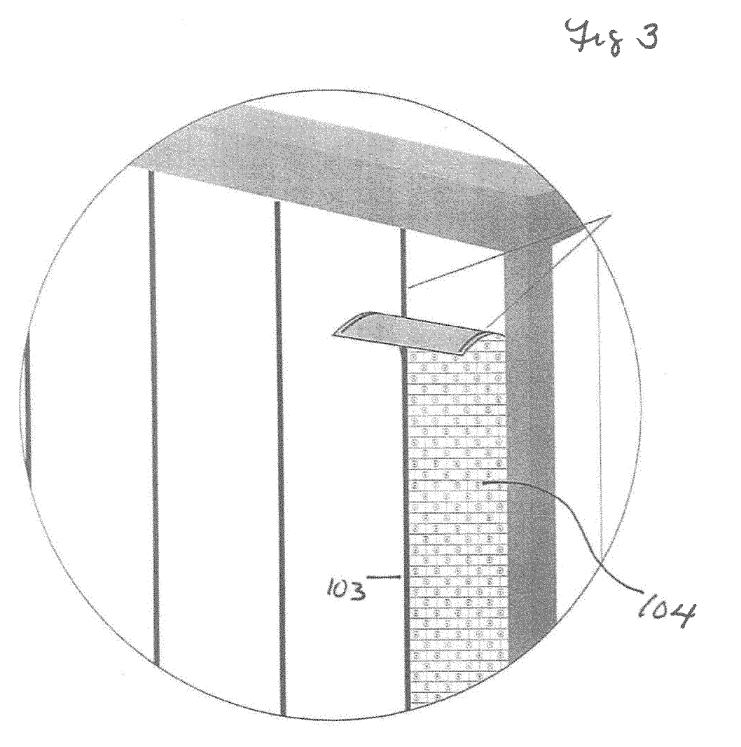

One also sees a plurality of black vertical lines “103.” These represent adhesive, such as pressure sensitive adhesive, or some other means of adhering the elements shown in FIG. 3. In practice, more adhesive is used than is shown, and any form of attachment means used to connect structures such as those shown, can be used.

FIG. 3 shows the attachment of one non-electroluminescent LED carpet “104,” comprising a plurality of LED carpet units. This LED unit fits precisely between two, parallel adhesive lines “103.” The placement of these vertical lines is determined by the size of the LED carpet 104. The edges of the longer sides of the LED carpet comprise additional pressure sensitive adhesive, or other adhesive means which interact with the adhesive or attachment means 102, to affix the LED carpet firmly thereto.

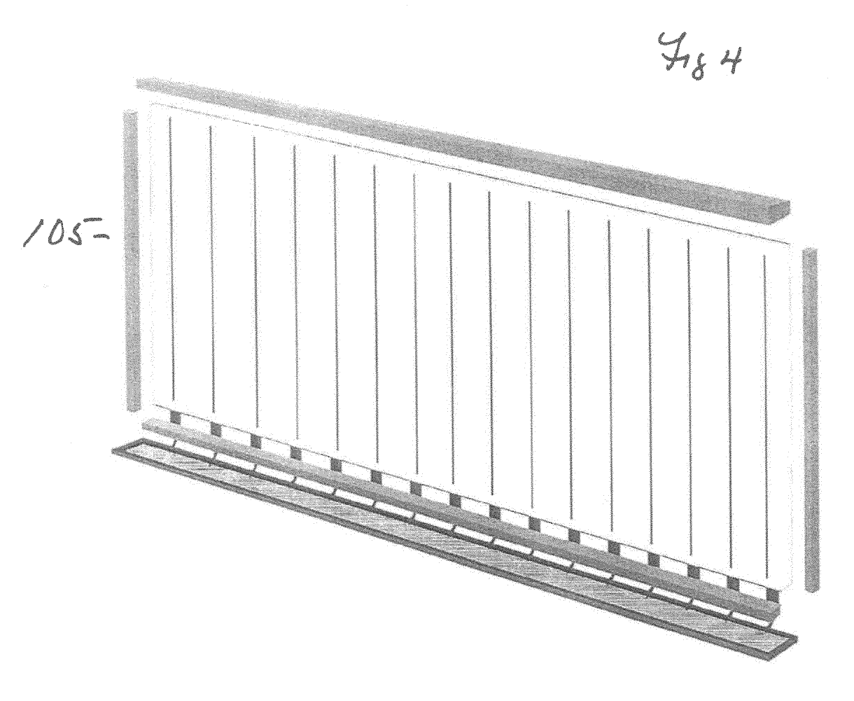

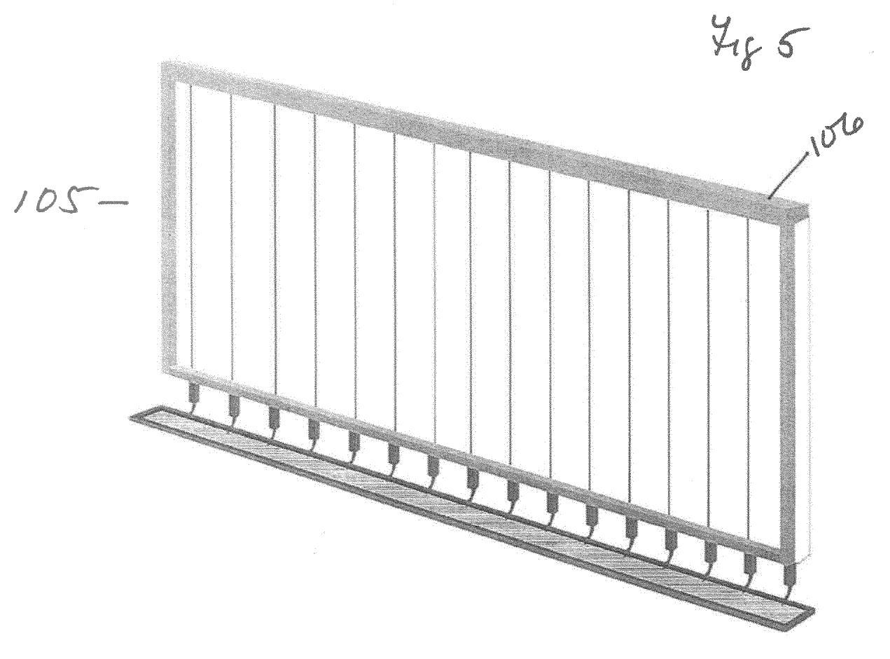

FIGS. 4 and 5 show a completed composite structure 105 with a framing element “106,” which is a part of the invention.

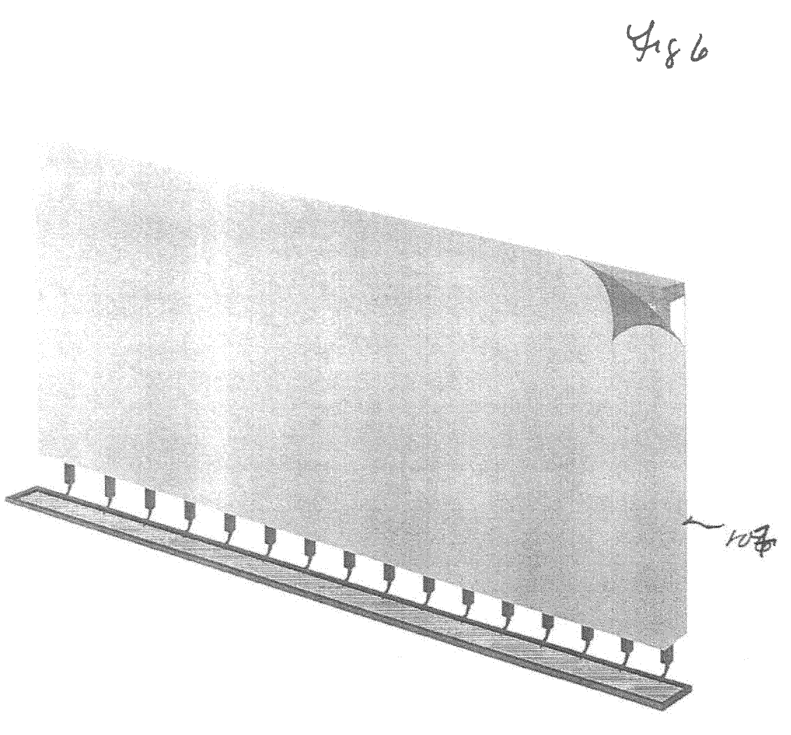

FIG. 6 shows the structure covered with a graphic wrap “107.” The graphic wrap is kept from contact with the LED carpet by a series of battens “108,” described infra. This graphic wrap is configured such that, when the LED carpet units are not activated, one image can be seen while a second, different image is seen when they are in fact activated. The graphic wrap is attached to the structure, such as via ratchets and gripper bars that create tension on all four sides. Other forms of attachment may also be used.

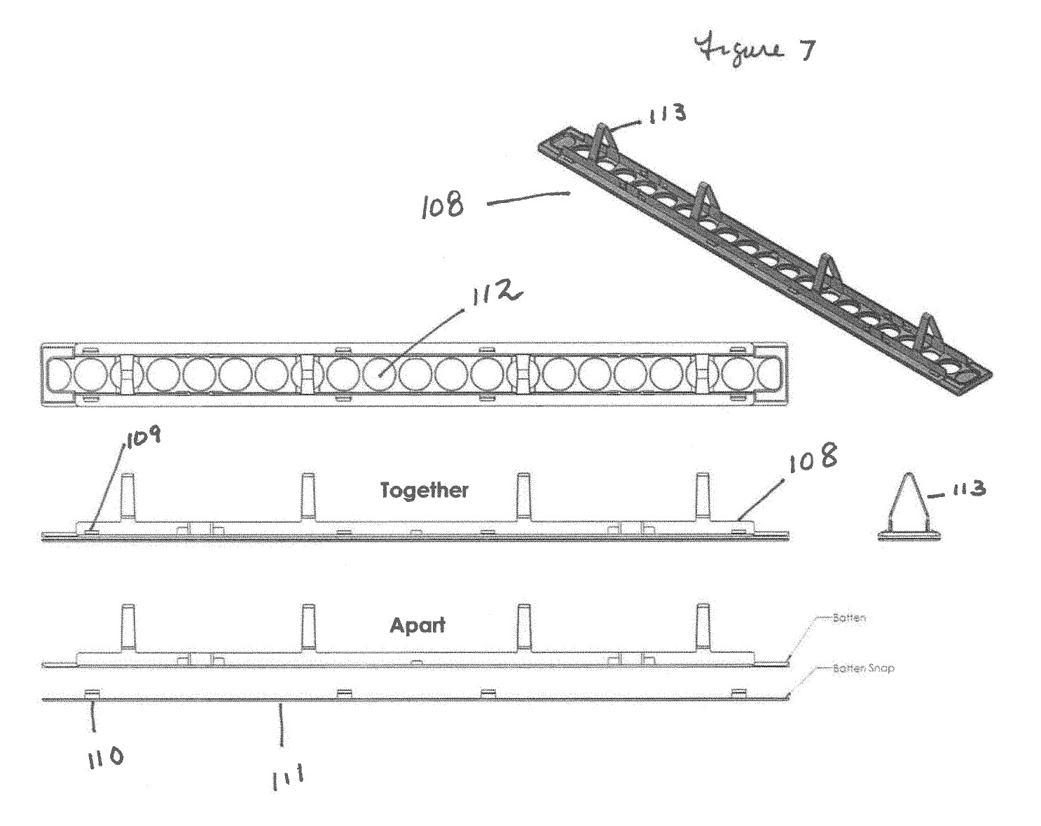

FIG. 7 shows various features of a batten used in an embodiment of the present invention. The batten system is a two-part, injection molded batten. Optionally provided at or near the outer edges of the complete batten “108” are one or more slots or openings “109.” The shape of slots “109” can be substantially rectangular so as to accommodate surface projection hooks “110” of base portion “111”; however, other shapes can be used. The one or more slots 109 can be optionally disposed on the batten 108 at locations corresponding with slots or openings provided on the LED carpet. Optionally provided between the two edges of batten 108 are a plurality of openings, one of which is marked as 112, provided for the purpose of allowing light to pass through the batten 108. The shape of the openings 112 can be circular. As such, the shape of the openings 112 can be designed to allow light from an LED diode to pass through the batten. Batten 108 can include one or more surface projections “113” provided for the purpose of separating the overlaying graphic wrap from the underlying LEDs. The shapes of the surface projections are non-united.

Batten 108 can include a base portion 111 comprising surface projection hooks extending perpendicular to the surface of the base portion 111. As such, the extensions can extend upwardly and pass through a slot of an LED carpet and further through slot 109 of batten 108 such that the base 111 and batten 108 snap together or are held together by other means, thereby holding the LED carpet rigidly in place. In a non-limiting embodiment, the material of the batten can, but need not be, clear, UV stabilized polycarbonate. As can be appreciated, other or alternative materials can be used. One batten can be disposed at every seam of the LED carpet. One batten can also be disposed at the top and bottom of the LED carpet; however, this is not required. In one non-limiting embodiment of the present invention, eighteen battens are provided for a LED carpet; however, it can be appreciated that other numbers of batten can be used.

A standard billboard is 14′×48′, although the size can vary. The number of LED carpet units, as noted supra, can be varied to fit the size of the composite structure of the invention. For example, in a preferred embodiment, the LED carpets measure 14′×2′, and 24 units are required.

With respect to the LED carpets, referred to supra, there are various embodiments and ways to illuminate the system described herein.

The light emitted from the LEDs can be partially guided, spread across the emissions area, and redirected. Many types of methods achieve such function, including etched lines or dots on the light board, and wedged light boards for controlled total internal reflections with light emissions. The light from the LED entering the light board can be spread by various diffusion mechanisms such that each LED covers a certain area with light with overlapping regions between the LEDs. The structural diffusing properties of the light board can be used to provide a uniform intensity profile across the surface of the light board; however, it can be appreciated that a non-uniform intensity profile can also be formed.

The light-diffusion properties provided by the LED billboard system of the present invention can optionally be such that the diffused angular distribution of light can be symmetrical in the x (i.e., the horizontal direction) and the y (i.e., the vertical direction) directions; however, this is not required. As can be appreciated, the angular distributions can be different in the x and the y directions. For example, it may be desirable to have a larger horizontal viewing angle than the vertical viewing angle.

In one non-limiting embodiment, a light sensor module can be used to control switching the LEI) carpets on and/or off. In another or alternative non-limiting embodiment, a clock-controlled module can be used to control switching the LED carpets on and/or off. The light sensor can also optionally be used to control brightness, color, wavelength, etc. of the one or more LED lights on a carpet and/or the lights on various carpets.

Traditional spotlight lighting systems on billboards provide substantially uneven light distribution across the front face of a billboard. One non-limiting advantage of the LED billboard system of the present invention is that the LED carpets used in the present invention can provide a substantially even light distribution across the partial or entire face of the billboard, or customized light distribution on various regions of the billboard.

To accommodate various orientations and locations of pre-existing and future billboards, the LED billboard system, according to one embodiment of the present invention, can be provided in which the orientation/angle of the billboard, distance from the billboard to intended viewer, brightness, and positioning of additional lighting fixtures (e.g., street lights, parking lot lights, etc.) can be compensated for by adjusting the LED lighting system. In this regard, different intensities of light may be required on different portions of the billboard. As such, the LED carpets can be controlled individually and be optionally adjusted such that the billboard is illuminated differently at various points across its surface.

Other features of the invention will be clear to the skilled artisan and need not be reiterated here.

The terms and expression which have been employed are used as terms of description and not of limitation, and there is no intention in the use of such terms and expression of excluding any equivalents of the features shown and described or portions thereof, it being recognized that various modifications are possible within the scope of the invention.

1. A composite structure lighting system, comprising:
(i) a support structure, having an opaque backing attached thereto;
(ii) a plurality of non-electroluminescent carpets affixed to said opaque backing via an attachment means;
(iii) a framing element surrounding said support structure;
(iv) a graphic wrap, and
(v) a plurality of batten means positioned on said support structure and positioned to separating said graphic wrap and said plurality of non-electroluminescent carpets.

2. The composite structure of claim 1, wherein said opaque backing has one side colored black.

3. The composite structure of claim 1, wherein said opaque backing is made of a synthetic material.

4. The composite structure of claim 3, wherein said synthetic material is plastic or rubber.

5. The composite structure of claim 1, wherein said attachment means is an adhesive.

6. The composite structure of claim 5, wherein said adhesive is pressure sensitive.

7. The composite structure of claim 1, wherein said non-electroluminescent carpets are LED carpets.

8. The composite structure of claim 1, wherein said graphic wrap comprises two images, each of which is on a side of said graphic wrap.

9. The composite structure of claim 1, wherein said graphic wrap is attached to said composite structure via ratchets and gripper bars.

10. The composite structure of claim 1, wherein said batten consists of two, injected molded parts.

11. The composite structure of claim 10, wherein said batten comprises one or more openings.

12. The composite structure of claim 11, wherein said openings are rectangular.

13. The composite structure of claim 1, wherein said batten comprises a base portion having a plurality of surface projection hooks perpendicular to said base portion.

14. The composite structure of claim 1, wherein said batten comprises one or more surface projections to separate said graphic wrap from said non-electroluminescent carpets.

15. The composite structure of claim 1, further comprising a light sensor module.
